(19) United States
(12) Patent Application Publication
(10) Pub. No.: US 2026/0030675 A1
(43) Pub. Date: Jan. 29, 2026

(54) CORPORATE WRAPPED BLOCKCHAIN SYSTEM AND METHOD

(71) Applicant: CAPSIGN INC., San Francisco, CA (US)

(72) Inventor: Matthew Rosendin, San Francisco, CA (US)

(73) Assignee: CAPSIGN INC., San Francisco, CA (US)

(21) Appl. No.: 19/283,079

(22) Filed: Jul. 28, 2025

Related U.S. Application Data
(60) Provisional application No. 63/676,028, filed on Jul. 26, 2024.

(51) Int. Cl. G06Q 40/04

(52) U.S. Cl. CPC G06Q 40/043; G06Q 40/051; G06Q 40/055

(57) ABSTRACT

Disclosed is a corporate wrapped blockchain; the corporate wrapper is implemented by a business entity that issues stock in the blockchain. The blockchain offers a plurality of stock classes that include a preferred stock and a common stock. The blockchain also includes a validator that owns preferred stock in the blockchain.

### PRIORITY CLAIM

This application claims the priority and benefit of U.S. Provisional Patent Application No. 63/676,028 filed on Jul. 26, 2024, which is incorporated by reference in its entirety.

### BACKGROUND

Blockchain technology is rooted in advances in cryptography and distributed computing, fields that have been evolving since the mid-20th century. Early work by cryptographers such as David Chaum in the 1980s on digital cash and anonymous communication laid the groundwork for later developments in secure digital transactions. One key innovation was introduced by Whitfield Diffie and Martin Hellman in 1976, which was a breakthrough in cryptographic security, enabling secure communications over an insecure channel. Merkle Trees, another innovation introduced by Ralph Merkle in 1979, allowed efficient and secure verification of data structures, which later became a critical component of blockchain technology.

The modern concept of blockchain was first implemented by an individual or group of individuals under the pseudonym Satoshi Nakamoto, who introduced a peer-to-peer electronic cash system. Nakamoto described a decentralized, peer-to-peer system for digital currency transactions that did not require a trusted third party. The key innovation was the blockchain, a public ledger that records all transactions in a chronological and immutable manner. This system relies on several fundamental technologies and concepts, such as proof of work. Proof of work is a consensus mechanism to ensure the security and integrity of the blockchain by requiring network participants to perform computationally intensive tasks. Another concept in the system is decentralization. Decentralization includes the elimination of a central authority, with transaction validation and record-keeping distributed across a network of nodes. A node is usually a computer that participates in the blockchain ledger. An additional concept in the system is an immutable ledger. Once recorded on an immutable ledger, data in any given block cannot be altered retroactively without altering all subsequent blocks, which requires network consensus.

Following the introduction of Nakamoto's peer-to-peer system for digital currency, blockchain technology rapidly gained attention and development. The early 2010s saw the emergence of various alternative cryptocurrencies that sought to improve upon or differentiate from Nakamoto's. During this period, significant developments included a system introduced by Vitalik Buterin in 2013 and launched in 2015, which expanded the functionality of blockchain technology by incorporating smart contracts. These self-executing contracts with the terms of the agreement directly written into code allowed for decentralized applications (dApps) to be built on the blockchain. Linux Foundation Corporation, in 2015, initiated a project aimed at advancing cross-industry blockchain technologies by providing a collaborative development environment. This project facilitated the creation of various blockchain frameworks, such as a modular blockchain framework that acts as a foundation for developing blockchain-based products, solutions, and applications using plug-and-play components that are aimed for use within private enterprises, which are used in enterprise applications.

In recent years, blockchain technology has continued to evolve and expand into new areas beyond cryptocurrency. Key trends and developments include scalability solutions, to address blockchain scalability issues have led to innovations such as a peer-to-peer payment protocol allowing users to send and receive cryptocurrencies quickly and inexpensively, and a scaling solution that allows a network or technology that operates on top of an underlying blockchain protocol to improve its scalability and efficiency. (e.g., rollups, sidechains). Other projects aim to enable interoperability between different blockchain networks, facilitating cross-chain transactions and communication. Other platforms leverage blockchain technology to provide financial services such as lending, borrowing, and trading without intermediaries. Non-Fungible Tokens (“NFTs”) have gained popularity as a way to represent ownership of unique digital assets on the blockchain, with applications in art, gaming, and entertainment.

Blockchain technology, originating from foundational cryptographic principles and early digital cash systems, has evolved significantly since the introduction of cryptocurrency in 2008. However, there are currently some weaknesses in blockchain technology, such as regulatory and legal challenges, governance, and usability. Regulatory and legal challenges have arisen because blockchains are new, and so the regulatory environment is ever evolving. Governance is a challenge because most blockchain governance is decentralized, which makes it difficult to reach a consensus. Legal challenges. Blockchains are complex and not user-friendly, and therefore makes it difficult to use.

Accordingly, it is the object of this disclosure to present a blockchain system and method that incorporates technologies and other more legally understood practices to help limit the weaknesses of other blockchains.

### SUMMARY OF THE DISCLOSURE

Disclosed herein is a corporate wrapped blockchain system and method.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings, where:

FIG. 1 illustrates a method of using a corporate wrapped blockchain.

FIG. 2 illustrates a system for implementing a corporate wrapped blockchain.

FIG. 3 illustrates a system for implementing different paths of block validation.

### DETAILED DESCRIPTION

In the following description of the disclosure, reference is made to the accompanying drawings, which form a part hereof, and in which are shown by way of illustration specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure, regardless of whether or not those elements are shown or described in another embodiment or figure. In other words, elements in the figures may be interchangeable between various embodiments disclosed herein, whether shown or not.

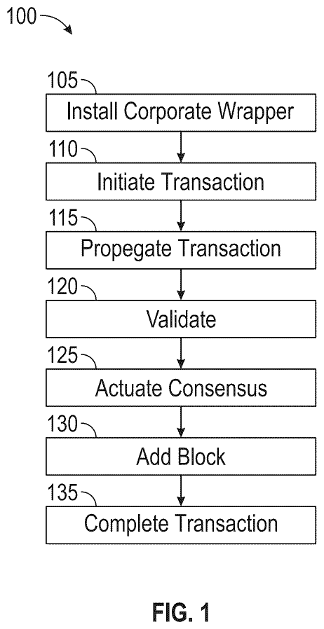

FIG. 1 illustrates a method of using blockchain 100. Step 105 of creating blockchain 100 may include installing a corporate wrapper for a business. This corporate wrapper acts as a framework or system that enables traditional corporations to interact with blockchain 100 efficiently and securely. This concept encompasses several aspects, including regulatory compliance, security, scalability, interoperability, and ease of use. Implementing a corporate wrapper with blockchain 100 may also provide more legal predictability because the legal precedence in dealing with corporate entities can provide a framework to manage the novelty of blockchain 100.

Step 110 may include initiating a transaction and may involve the purpose of the business. For example, the transaction may include signing a document or transferring money (e.g., fiat currency, commodity currency, representative currency or digital currency). Alternatively, the transaction may include but is not limited to a smart contract transaction, a token transaction, an atomic swap, an interchain transaction, a voting and governance transaction, and/or a data transaction. The transaction in step 110 may be limited to shareholders of the business. The business may have two different types of stock, namely, preferred stock and common stock. Ownership in each stock may represent certain privileges provided within blockchain 100. Further, ownership in corporate wrapped blockchain 100 may be required to perform the transaction.

Once step 110 is completed, the transaction may be propagated to different nodes in step 115. Node hosting may be performed on-premises or through a hosted service performed by blockchain 100, the entity that implemented the corporate wrapper, or third parties. Node “providers” may offer network access through their own distribution/customer lists if they meet regulatory criteria. Step 115 may be completed by the same business entity that constitutes the business wrapper and processes the transaction. Accordingly, in step 115, that business entity may propagate the transaction to different nodes. Alternatively, the propagating business may be a different business entity. It may be required that any business that is involved in the maintenance of blockchain 100 have ownership in blockchain 100 either through common stock or preferred stock. These nodes may also be controlled by the same business entity. Therefore, hosting the nodes and running the validation node service may be the same business entity that constitutes the corporate wrapper of bl. In an alternative embodiment, if the business entity that hosts nodes and runs the validation service is a different business entity from the business entity that incorporates the corporate wrapper, the new business entity may be required to be a stockholder of blockchain 100.

Entities or individual owners of the business may validate the transaction in step 120. Step 120 validation may take place before step 115 propagation. Validators in step 120 may be limited to owners of preferred stock. Preferred stockholders may validator nodes and may receive stock dividends as an incentive. All validators may be required to be shareholders in blockchain 100. Further, validators may be required to be preferred stockholders. It may be set up that common stockholders may receive no dividends, but common stockholders may benefit from the appreciation of the stock price of blockchain 100. Before going public, blockchain 100 may issue a Regulation Crowdfunding (“Reg. CF”) to allow retail participation.

In step 125, nodes in the network work to achieve consensus on the new block using a consensus mechanism. With blockchain 100, the consensus mechanism may be proof of stake (“PoS”). Also, delegated proof of stake (“DPoS”) may be used with or in place of PoS. Alternatively, blockchain 100 may also use other consensus mechanisms including but not limited to proof of work (“PoW”), proof of authority (“PoA”), proof of burn (“PoB”), proof of elapsed time (“PoET”), practical byzantine fault Tolerance (“PBFT”), or a hybrid consensus mechanism that uses one or more of the listed examples.

In step 130, once consensus has been reached, the new block may be added to blockchain 100. The blockchain may then be updated across all nodes, ensuring consistency. In step 135, the transaction is completed and the newly created block is now part of the blockchain, and the block may be considered confirmed. As a result, the newly created block may become a permanent and immutable part of the ledger.

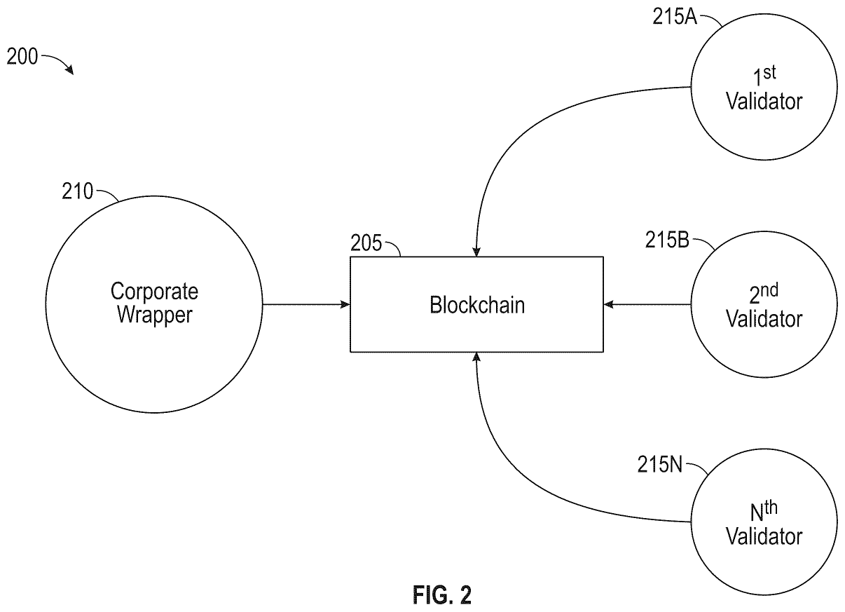

FIG. 2 illustrates system 200 for implementing corporate wrapped blockchain 205. The beginning process of creating corporate wrapped blockchain 205 may include the creation of a corporation that can function as corporate wrapper 210. Further, the corporation may function to actuate commercial contracts, function as a technical service provider, host a validator node service, run a validator node, and implement network upgrades to blockchain 205. Additionally, the corporate wrapper 210 may be set up to go public on the stock market to be traded on national securities exchanges after going public. Corporate wrapper 210 may register as a clearing agency. Corporate wrapper 210 may require preferred shareholders to register and run a validator node.

Blockchain 205 may be set up before or after the corporation that will become the corporate wrapper 210. With the implementation of corporate wrapper 210, blockchain 205 may include one or more types of stock. For example, the corporation may have a preferred and a common stock. Those individuals or entities that own preferred stock may become validators and may receive dividends as incentives. Those individuals or entities that own common stock may receive increased value in the stock as stock prices rise. Before going public, blockchain 205 may issue a regulation crowdfunding (“Reg. CF”) to allow retail participation. Further, individuals or entities that own common stock may run a full-history or light client node, but may be ineligible for dividends issued from the validation process. A corporate wrapper may also be a shareholder of Blockchain 205.

Validators 215A-N may be preferred shareholders. As preferred shareholders, they may vote on material changes to the shared ledger, and the specifics of how governance works are defined in the bylaws. Network/corporate governance may work by casting digitally signed votes on the network, using the corporate bylaws as a governance framework, and smart contracts coded to the bylaws. There may be multiple share classes, some that receive dividends as a validator incentive, and others as common stock, benefitting from price appreciation. To further allow public access to blockchain 205, an S-1 may be filed with the SEC to allow a public market for the stock of blockchain 205, which may be a digital asset security.

Ownership of blockchain 205 may be capped at a specific percentage. For example, the blockchain 205 may cap ownership and voting power at 10% for any one entity. New members may apply for registration as a member. Blockchain 205 may include an owner registry. Membership may be recorded by the managing member in the owner registry. Prior to applying, new member applicants may be required to hold a certain number of tokens from blockchain 205 acquired on the secondary market or through issuance of new shares through corporate wrapper 210.

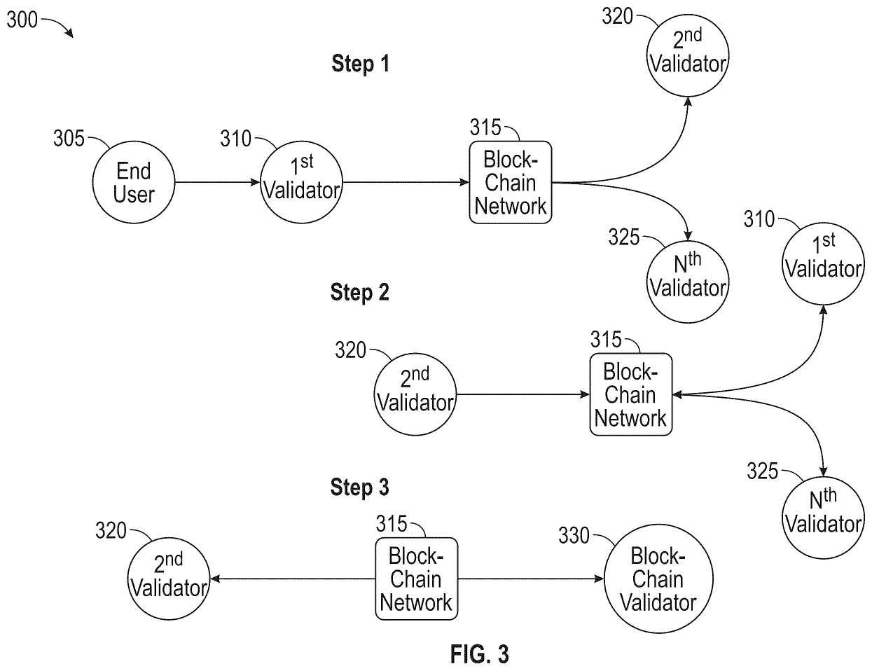

FIG. 3 illustrates blockchain system 300 of implementing different paths of block validation and confirmation using blockchain network 315. In step 1, end user 305 submits a transaction related to first validator 310. End user 305 may use a computing device associated with the end user to submit the transaction. First validator 310 may submit the transaction of end user 305 to blockchain network 315 and may use a computing device associated with the first validator 310. Blockchain network 315 may broadcast the transaction of end user 305 to other validators, such as a second validator 320 or an N^{th} validator 325. The lead block producer, such as first validator 310 may select the transaction from end user 305 from the mempool to include in the block being produced. First validator 310 may assemble a block with a selected transaction. Further, first validator 310 may propose the block to blockchain network 315. All validators may be limited to preferred stockholders.

In Step 2 dividend may be issued either to the block producer/leader. In many Proof-of-Authority (PoA) configurations, there may be no block reward/incentive, and blocks may be validated by the signatures of a majority (or predefined threshold) of the other validators. In Proof-of-Stake (PoS), the lead block is confirmed by a consensus of other validators, who check the block for validity, typically with a supermajority agreement, predefined threshold, or other method. Blockchain system 300 may implement a way to require the identities of validators to be known, and there may be a pseudo-random algorithm that weighs selection by identity/reputation; holdings may or may not factor in. This consensus mechanism may be mutable through the governance process.

In step 3, dividends may be issued, and transaction fees may be collected from the treasury account of blockchain network 315. Block rewards typically include both newly minted coins and transaction fees. In blockchain network 315, dividends may be issued instead of “minting coins” (although they are similar), which increases the total outstanding stock, and the block producer may or may not collect transaction fees as dictated in the governance documents. Transaction fees accrue to the treasury of the blockchain network, which creates claimable value for all shareholders. Ownership may be capped at 10%, so stock dividends beyond this may have no effect. Blockchain network 315 may issue a stock dividend to 2^{nd} validator 320. Blockchain network 315 may send transaction fees to the corporate treasury account. Transaction fees can be paid in any currency (e.g., fiat currency, commodity currency, representative currency or digital currency).

Second Validator 320 and all other shareholders, including common stock shareholders, have a claim on blockchain network 315's treasury assets. Dividends are issued as digital asset securities, which are recorded on the blockchain network 315 as a native asset or a custom token.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A blockchain comprising:
a corporate wrapper by a business entity that issues stock in the blockchain;
wherein the blockchain offers a plurality of stock classes comprising:
a preferred stock,
a common stock; and
a validator that owns preferred stock in the blockchain.

2. The blockchain of claim 1, further comprises:
a plurality of validators.

3. The blockchain of claim 2, validates transactions of the business entity using one or more validators.

4. The blockchain of claim 3, wherein the identities of the validators are displayed as part of the transaction.

5. The blockchain of claim 3, wherein one of the one or more validators is an entity.

6. The blockchain of claim 3, wherein one of the one or more validators is an individual.

7. The blockchain of claim 3, wherein the validators receive no incentive for validating a transaction.

8. The blockchain of claim 3, wherein the validators receive an incentive for validating a transaction.

9. The blockchain of claim 8, wherein the validators receive stock dividends as an incentive for validating a transaction.

10. The blockchain of claim 3, includes signing documents as a transaction.

11. The blockchain of claim 3, includes money transfers as a transaction.

12. The blockchain of claim 3, includes a smart contract as a transaction.

13. The blockchain of claim 3, includes a token transfer as a transaction.

14. The blockchain of claim 3, includes an atomic swap as a transaction.

15. The blockchain of claim 3, includes an interchain transaction as a transaction.

16. The blockchain of claim 3, includes a voting and governance action as a transaction.

17. The blockchain of claim 3, includes a data transfer as a transaction.

18. The blockchain of claim 1, performs node hosting under the corporate wrapper.

19. The blockchain of claim 1, outsources the node hosting to a third party.

20. The blockchain of claim 19, wherein the node hosting third party is a preferred stockholder.
